(19) United States
(12) Patent Application Publication
(10) Pub. No.: US 2008/0119179 A1
(43) Pub. Date: May 22, 2008

(54) METHOD AND SYSTEM FOR REMOTELY CONTROLLING A PORTABLE WIRELESS COMMUNICATION HANDSET

(75) Inventors: ROBERT F. LAY, ELGIN, IL (US); SOUVIK GHOSH, LAKE ZURICH, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/561,720

(22) Filed: Nov. 20, 2006

(51) Int. Cl. H04M 3/00

(52) U.S. Cl. 455/419

(57) ABSTRACT

A method and system for remotely controlling a portable wireless communication handset is disclosed. The method includes receiving (304) a control signal at a wireless accessory transceiver of the portable wireless communication handset. The method also includes interpreting (308) the control signal to control a function of the portable wireless communication handset when a condition is satisfied. Moreover, the method includes re-mapping (312) the control signal to control a function of an application controlled accessory, only when the application controlled accessory is running and the condition is not satisfied.

### FIELD OF THE DISCLOSURE

The present disclosure relates generally to portable wireless communication handsets, and more specifically to methods and systems for remotely controlling application controlled accessories of a portable wireless communication handset.

Portable electronic devices including cellular telephones, pagers, personal digital assistants and the like now include a host of embedded features. Examples of such features include image capture capability, multimedia playback capability, navigation, calendar and information management features, among others. These portable electronic devices are also used commonly with accessories, for example, Bluetooth and wire-line headsets, capable of controlling accessory-related functions, for example, SEND and volume control, from the accessory.

Various aspects, features and advantages of the disclosure will become more fully apparent to those with ordinary skill in the art on careful consideration of the following Detailed Description and the accompanying drawings described below. The drawings may have been simplified for clarity and are not necessarily drawn to scale.

### BRIEF DESCRIPTION OF THE FIGURES

FIG. 1 illustrates a wireless communication environment.

FIG. 2 illustrates a block diagram of the portable wireless communication handset.

FIGS. 3 and 4 illustrate a flowchart for remotely controlling a portable wireless communication handset.

FIG. 5 is a flow diagram for remotely controlling the portable wireless communication handset.

### DETAILED DESCRIPTION

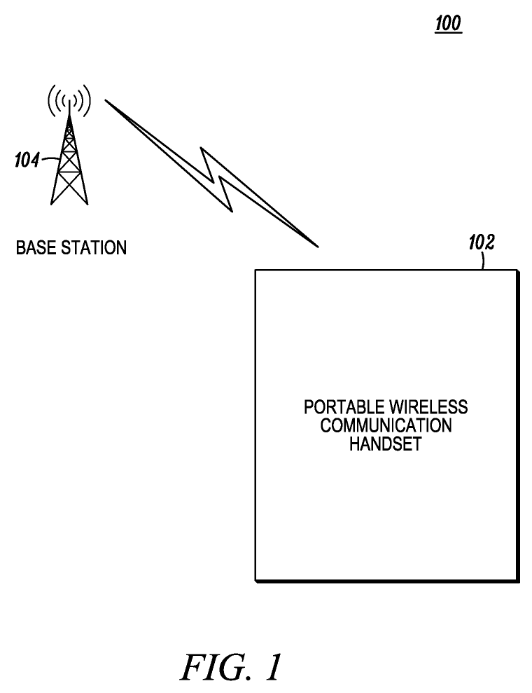

FIG. 1 illustrates a wireless communication environment 100 including a portable wireless communication handset 102 and a base station or wireless access point 104. The portable wireless communication handset 102 can be a portable communication device or an electronic device for telecommunication such as a mobile telephone, a laptop, a palmtop, a Personal Digital Assistant (PDA), a smart phone, and the like. The disclosure however is not limited to use on portable wireless communication handsets, since it is applicable more generally to any portable electronic device, as discussed more fully below.

The portable electronic device includes an accessory transceiver that communicates with a remote accessory. The remote accessory may communicate wirelessly, for example, via the Bluetooth protocol, or by a wire-line connection with the accessory transceiver. Exemplary remote accessories include wire-line and wireless headsets among other accessories. A wireless headset typically includes function controls, like PLAY, STOP, SEND, volume, etc., for controlling the headset. For example, if the wireless headset accessory is used with a portable multimedia playback device, the function controls on the wireless headset may be used to select media, to start and stop playback, and to control volume, etc. In wireless communication device applications, like cell-phones, the function controls on the wireless headset may be used to answer incoming calls, access the phone book and send outgoing calls, control volume, etc.

The portable electronic device also includes one or more application controlled accessories. For example, the application controlled accessory can be an image capture accessory, a navigation accessory, a game accessory, a media playback accessory, among other applications controlled accessories. In one embodiment, the application controlled accessory is embedded in the portable electronic device. In another embodiment, the application controlled accessory is a built-in function of the device. The application controlled accessory generally includes a software application and may include dedicated hardware. A satellite navigation receiver is an example of an application controlled accessory that includes dedicated hardware in the form of a satellite receiver. A game or multimedia player is an example of an application controlled accessory that uses hardware, for example a processor, audio system and user-interface of the portable electronic device without requiring dedicated hardware. The application controlled accessory is typically controlled from a user-interface of the portable electronic device.

According to another aspect of the disclosure, the application controlled accessory can be controlled by a control signal produced by another accessory. Ordinarily, when a condition is satisfied, the control signal controls a function of the portable wireless communication handset when a condition is satisfied. This function is typically related to the remote accessory, for example, controlling the audio provided to a wireless headset. Thus when a condition is satisfied, for example, the wireless headset is enabled, the control signal controls a function of the portable wireless communication handset. The wireless head set may be enabled when the user is in a voice call of listening to some other audio media.

In one embodiment, under certain circumstances, a control signal received by the wireless accessory transceiver from the wireless accessory, for example, a wireless head set accessory, is re-mapped to control a function unrelated to the wireless controlled accessory that sent the control signal. For example, the control signal may be used to control an application controlled accessory. One such circumstance may be that the application controlled accessory is running and that some other condition is or is not satisfied. The other condition may be that the wireless accessory that sent the signal is not enabled, for example, not receiving audio associated with a voice call or a audio media. Thus even where the application controlled accessory is running, the control signal is interpreted for controlling the function of the portable wireless communication handset when the condition is satisfied. In other words, control of the portable electronic device has priority over control of the application controlled accessory when the condition is satisfied, e.g., during a voice call, regardless of whether the application controlled accessory is running.

In one embodiment, the application controlled accessory is an image capture accessory, and the control signal is re-mapped to a function of the image capture accessory when an application associated with the image capture accessory is running and the condition is not satisfied, i.e., the control signal is not controlling a function of the portable electronic device. For this exemplary implementation, the control signal could be re-mapped to control a function selected from a group of: activating/de-activating; shutter control; focus; click; flash control; color settings; saving option; display feature; post view; sound settings; day/night mode settings; resolution control; and zoom when the application associated with the image capture accessory is running.

In another embodiment, the application controlled accessory is a navigation accessory, and the control signal is re-mapped to a function of the navigation accessory when an application associated with the navigation accessory is running and the condition is not satisfied, i.e., the control signal is not controlling a function of the portable electronic device. For this exemplary implementation, the control signal could be re-mapped to control a function of the navigation accessory selected from a group of: map image panning; map image zooming; and map image selection when the application associated with the navigation accessory is running.

In FIG. 1, the portable wireless communication handset 102 can be in communication with the base station 104. In this embodiment, the base station 104 can be a transceiver of a mobile network service provider, which is capable of receiving and transmitting signals to portable wireless communication handset. Examples of the base station 104 include but are not limited to a Base Transceiver Station (BTS), a Base Station Controller (BSC), and a mobile station. The base station 104 enables the portable wireless communication handset 102 to establish a communication link with the mobile communication network. For example, the portable wireless communication handset can establish a voice call connection through the BTS. The voice call connection is then controlled through the accessory hardware.

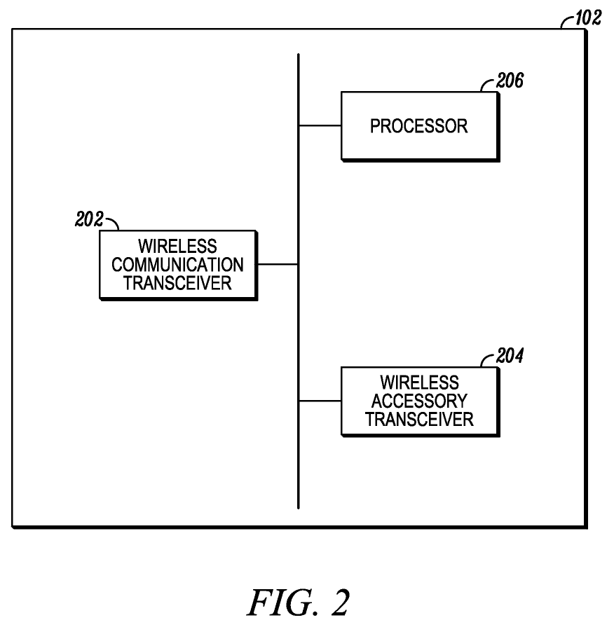

FIG. 2 illustrates a block diagram of the portable wireless communication handset 102, for example, a cellular telephone. The portable handset 102 comprises a wireless communication transceiver 202, a wire-line or wireless accessory transceiver 204 and a processor 206. The wireless communication transceiver 202 is configured to receive a signal from a base station, for example, the base station 104. The accessory transceiver 204 is capable of receiving a control signal at the portable wireless communication handset. The accessory transceiver 204 enables the portable wireless communication handset 102 to establish a communication link with related remote accessory hardware coupled to the handset 102 wirelessly or by wire-line. In the embodiment described above, the wireless communication transceiver 202 and the wireless accessory transceiver 204 are communicably coupled to the processor 206. The processor 206 is configured, for example, by a software program, to interpret the control signal received by the wireless accessory transceiver 204. Particularly, the processor 206 is configured to determine whether a control signal received by the accessory transceiver is should control a function of the handset 102 (typically associated with the remote accessory) or an application controlled accessory unrelated to the remote accessory. The processor is also configured to re-map the control signal received by the wireless accessory transceiver 204 if necessary, for example, if a condition is not satisfied. An example of the condition can be checking whether the portable wireless communication handset 102 is engaged in a voice call. As noted above, the control signal would only be re-mapped if the application controlled accessory is running or enabled.

In software implementations, the system for controlling a portable wireless communication handset 102 includes a memory (not shown in FIG. 2) communicably coupled with the processor 206. The memory can be configured to store instructions for controlling the portable wireless communication handset 102 and particularly a software-programmable processor. For example, the memory can be configured to store a control instruction of a camera function or a radio function of the mobile telephone. The memory can be programmed to store instructions for different accessory controlled applications according to the user's requirements.

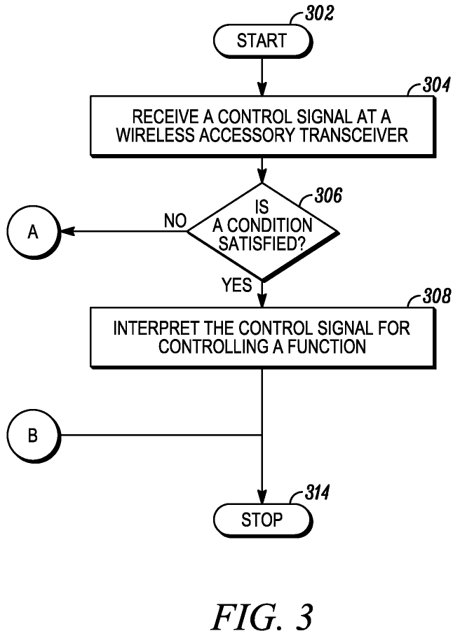

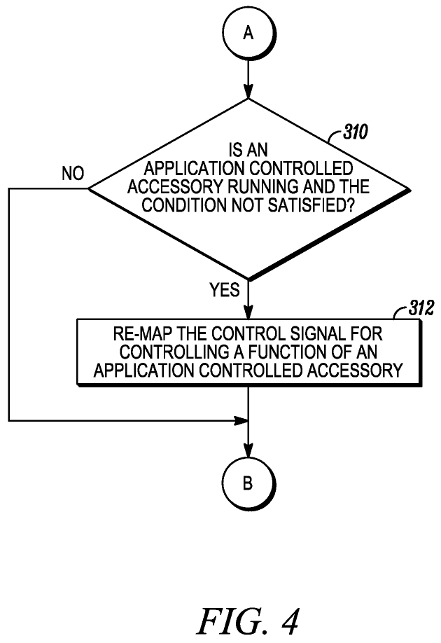

FIGS. 3 and 4 illustrate a flowchart for remotely controlling the portable wireless communication handset 102. In FIG. 3, at 302, remote control of the portable wireless communication handset 102 is initiated. At 304, a control signal is received at an accessory transceiver, for example, the wireless accessory transceiver 204 in FIG. 2. The control signal can be used to control a function of the application controlled accessory and/or a function of the portable wireless communication handset. In other words, it can either make a call on the portable wireless communication handset or it can control the application controlled accessory. In FIG. 3, at 306, a condition is checked by a processor, for example, the processor 206 in FIG. 2. In one embodiment, the condition can be a voice call, which can be an incoming voice call, an outgoing voice call, a waiting voice call, and the like. In FIG. 3, the process proceed to 308 if the condition is satisfied, otherwise the process proceeds to 310. At 308, the control signal is interpreted, based on the condition. In this embodiment, the processor 206 interprets the control signal if the conditions pertaining to the voice call are confirmed. For example, if the processor 206 carries out a check and detects a voice call. If the voice call condition is satisfied, regardless of whether any application controlled accessory is running, for example, the application controlled accessory for image capture application is running, the processor 206 interprets the control signal as an instruction to control a function pertaining to a voice call of the portable wireless communication handset 102. For example, the control signal is interpreted as an instruction relating to a function of a calling application. Examples of the function of the portable wireless communication handset 102, pertaining to the calling application, can be a volume control, answering a call, call initiation, audio mute, hold, call transfer, call termination functions, and the like.

In FIG. 4, at 310, another check is carried out at step 310 if the condition is not satisfied at step 306. The check is carried out at step 310 to confirm if the application controlled accessory is running and whether the condition is not satisfied. If the condition pertaining to the voice call is not satisfied and the application controlled accessory is running, the process proceed to 312, or it terminates at 314. At 312, the control signal is re-mapped as a control instruction for a function of the application controlled accessory of the portable wireless communication handset. For example, the control signal can be re-mapped as the activating/de-activating function, shutter control function, zoom function, focus function, capture function, click function, flash control function, color mode setting, resolution control function, saving option, display feature, post view function, sound settings, day/night mode settings, and the like, of the image capture application controlled accessory. The control signal can be re-mapped as the control instruction for the various application controlled accessories. These application controlled accessories can be value-added features or functionalities/applications of the portable wireless communication handset 102, other than calling application. An accessory controlled application can be an image capturing application, a gaming application, a calendar, an alarm function, a radio application, a navigation application, and the like. The control signal received by the wireless accessory transceiver 204 can be re-mapped for various operations and functions of the application controlled accessory. The control signal can be re-mapped, based on the type of the application controlled accessory running. For example, the control signal can be re-mapped for the functioning of an application controlled accessory such as a navigation application, a gaming application, and the like. For the navigation application, the control signal can be re-mapped for a function such as map image panning, map image zooming, map image selection, and the like. The functions of the various application controlled accessories can be customized, based on users' preferences. For example, re-mapping of the control signal by the processor 206 can be customized for the application controlled gaming accessory. The control signal can be re-mapped to control a function such as cursor movement or the select and game mode select associated with the application controlled gaming accessory. Further, the control signal can be re-mapped as a set of instructions to start the navigation accessory or tune a radio channel of a radio accessory, depending on the customization settings of the user. Thereafter, the method terminates at 314.

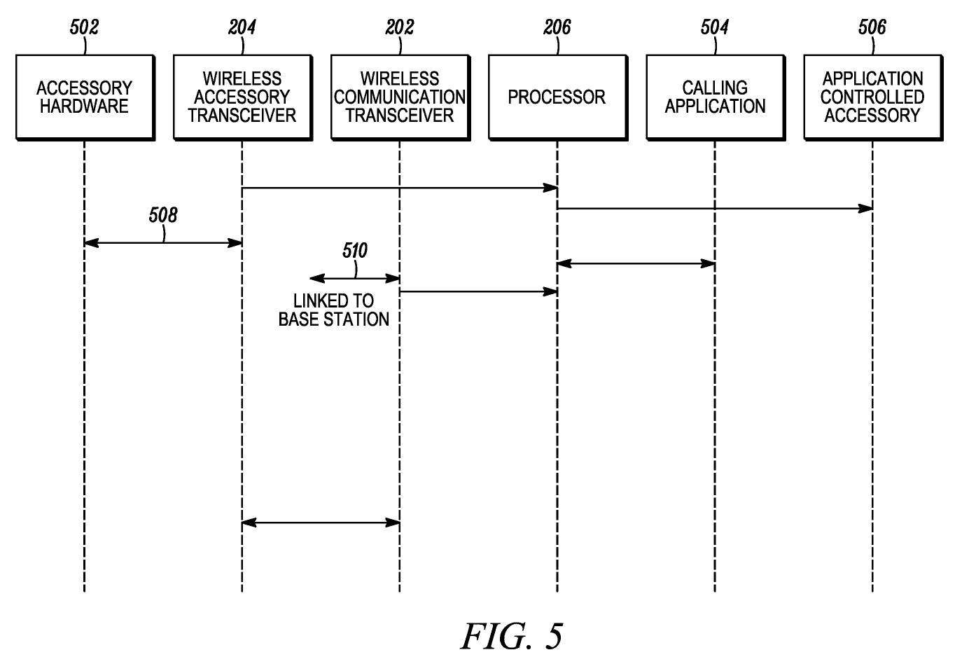

FIG. 5 is a flow diagram for controlling a portable wireless communication handset in accordance with another embodiment of the disclosure. The flow diagram for controlling the portable wireless communication handset is explained in conjunction with FIGS. 1 and 2. In this embodiment, the flow diagram includes references to a wireless communication transceiver, a wireless accessory transceiver, and a processor, examples of which are illustrated in FIG. 2. The flow diagram also includes accessory hardware 502, a calling application 504, an application controlled accessory 506, a control signal 508 and a communication signal 510. The accessory hardware 502 can be a control device that can remotely send the control signal 508 to a portable wireless communication device, for example the handset 102 of FIG. 1. Examples of the accessory hardware 502 include but are not limited to a hands-free set, a Wi-Fi accessory, or a Bluetooth accessory. The accessory hardware 502 sends the control signal 508 to the accessory transceiver, either wirelessly or by a wire-line protocol. The control signal 508 includes instructions for controlling the application controlled accessory 506 of the portable wireless communication device, for example, a mobile telephone. The application controlled accessory 506 can be an image capturing accessory. Further, the control signal 508 is transmitted to the processor, which is configured to check a condition of the portable wireless communication handset. For example, the processor can check whether the mobile telephone is in a voice call. If the condition is not satisfied, for example, there are no voice calls and the application controlled accessory 506 is active, the processor re-maps the control signal related to the application controlled accessory 506, for example, the image capture accessory. In this implementation, the control signal 508 sent by the accessory hardware 502 can control various functions such as zoom, click, focus, shutter control, activate/de-activate, saving option, flash control, color settings, display feature, type of view, post view, sound settings, day/night mode settings, resolution control, and the like, of the image capture accessory.

In FIG. 5, a communication signal 510 from the base station, for example, the base station 104 of FIG. 1, can be received by the wireless communication transceiver, which transmits the communication signal 510 to the processor. The processor is configured to receive the communication signal 510. Further, the processor can simultaneously receive the control signal 508 from the accessory hardware 502 and the communication signal 510 from the base station. The processor is configured to check the condition before transmitting the control signal 508. For example, the processor is configured to check whether the portable wireless communication handset is in a voice call. On detecting the voice call, in the form of a communication signal 510, the control signal 508 is interpreted as the control instruction for calling application 504. The control instruction can control functions such as holding a voice call, answering, rejecting, and transferring a voice call related to calling application 504. Alternatively, if the processor checks the condition and finds no voice call, it checks again to determine whether the application controlled accessory 506 is in a running mode (functional mode). On detecting the running mode and the absence of a voice call, the processor re-maps the control signal into an instruction for controlling the application controlled accessory 506. For example, when there is no voice call, and an application controlled accessory 506, such as an image capture accessory is running, then the control signal, is re-mapped to control functions of the image capture accessory. Examples of the function of the image capture accessory may include but are not limited to an activating/de-activating function, a shutter control function, a zoom function, a focus function, a capture function, a click function, a flash control function, color mode settings, a resolution control function, a saving option, a display feature, a post-view function, sound settings and day/night mode settings.

In yet another embodiment, while clicking a self-image by using the image capture accessory and a camera integrated with the mobile telephone, a user can keep the portable wireless communication handset at a distance and then click a picture by using the accessory hardware 502. The control signal 508 for clicking the image is received by the wireless accessory transceiver. The control signal 508 is then sent to the processor. The processor checks whether there is no voice call and then re-map the control signal 508 as an instruction for image capturing. On the other hand, if there is a voice call, the control signal 508 from the wireless communication transceiver is interpreted as an instruction for the calling application 504.

It is expected that one with ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

While the present disclosure and the best modes thereof have been described in a manner establishing possession and enabling those with ordinary skill to make and use the same, it will be understood and appreciated that there are equivalents of the exemplary embodiments disclosed herein, and that modifications and variations may be made thereto, without departing from the scope and spirit of the inventions, which are limited not by the exemplary embodiments but by the appended claims.

What is claimed is:

1. A portable wireless communication handset comprising:
a processor communicably coupled to a memory;
a wireless communication transceiver communicably coupled to the processor;
a wireless accessory transceiver communicably coupled to the processor; and
an application controlled accessory communicably coupled to the processor,
the processor configured to re-map a control signal received by the wireless accessory transceiver, from controlling a function of the portable wireless communication handset, to controlling a function of the application controlled accessory when the application controlled accessory is running.

2. The handset of claim 1, the processor configured to interpret the control signal received by the wireless accessory transceiver for controlling the function of the portable wireless communication handset when the portable wireless communication handset is in a voice call regardless of whether the application controlled accessory is running.

3. The handset of claim 1,
the application controlled accessory is an image capture accessory; and
the processor configured to re-map the control signal to a function of the image capture accessory when an application associated with the image capture accessory is running.

4. The handset of claim 3, the processor configured to re-map the control signal to control a function selected from a group of: activating/de-activating; shutter control; focus; click; flash control; color settings; saving option; display feature; post view; sound settings; day/night mode settings; resolution control; and zoom when the application associated with the image capture accessory is running.

5. The handset of claim 1, the processor configured to interpret the control signal received by the wireless accessory transceiver for controlling the function selected from a group of: volume control; call initiation; call termination; and audio mute when the when the portable wireless communication handset is in a voice call regardless of whether the application controlled accessory is running.

6. The handset of claim 1,
the application controlled accessory is a navigation accessory; and
the processor configured to re-map the control signal to a function of the navigation accessory when an application associated with the navigation accessory is running.

7. The handset of claim 6, the processor configured to re-map the control signal to control the function of the navigation accessory selected from a group of: map image panning; map image zooming; and map image selection when the application associated with the navigation accessory is running.

8. A method in a portable wireless communication handset, the method comprising:
receiving a control signal at a wireless accessory transceiver of the portable wireless communication handset,
the control signal controlling a function of the portable wireless communication handset when a condition is satisfied; and
re-mapping the control signal for controlling a function of an application controlled accessory only when the application controlled accessory is running and the condition is not satisfied.

9. The method of claim 8, interpreting the control signal for controlling the function of the portable wireless communication handset when the portable electronic handset is in a voice call.

10. The method of claim 8, interpreting the control signal for controlling the function of the portable wireless communication handset when the condition is satisfied regardless of whether the application controlled accessory is running.

11. The method of claim 8,
re-mapping the control signal for controlling the function of an application controlled accessory when the application controlled accessory is running only if the portable wireless communication handset is not in a voice call.

12. The method of claim 8,
interpreting the control signal for controlling the function of the portable wireless communication handset when the portable wireless communication handset is in a voice call; and
re-mapping the control signal for controlling a function of an application controlled gaming accessory only when the application controlled gaming accessory is running and the portable wireless communication handset is not in a voice call.

13. The method of claim 12,
re-mapping the control signal for controlling the function of the application controlled gaming accessory selected from the group of: cursor movement, select and game mode select when the application controlled gaming accessory is running and the portable electronic handset is not in a voice call.

14. The method of claim 8,
interpreting the control signal for controlling the function of the portable wireless communication handset when the portable wireless communication handset is in a voice call; and
re-mapping the control signal for controlling a function of an application controlled image capture accessory only when the application controlled image capture accessory is running and the portable wireless communication handset is not in a voice call.

15. The method of claim 8,
interpreting the control signal for controlling the function of the portable wireless communication handset when the portable wireless communication handset is in a voice call; and
re-mapping the control signal for controlling a function of an application controlled navigation accessory only when the application controlled navigation accessory is running and the portable wireless communication handset is not in a voice call.

16. A method in a portable electronic device, the method comprising:
receiving a control signal at an accessory transceiver of the portable electronic device, the accessory transceiver associated with a remote accessory,
the control signal controlling a function of the portable electronic device associated with the remote accessory when a condition is satisfied; and
re-mapping the control signal for controlling a function of an application controlled accessory, unrelated to the remote accessory, only when the application controlled accessory is running and the condition is not satisfied.
